(19) United States
(12) Patent Application Publication
(10) Pub. No.: US 2025/0080813 A1
(43) Pub. Date: Mar. 6, 2025

(54) CAMERA AND METHOD FOR ADJUSTING IMAGE DATA

(71) Applicant: TRIPLE WIN TECHNOLOGY (SHENZHEN) CO.LTD., Shenzhen (CN)

(72) Inventor: KUAN-MING CHEN, New Taipei (TW)

(21) Appl. No.: 18/603,415

(22) Filed: Mar. 13, 2024

(30) Foreign Application Priority Data
Aug. 31, 2023 (CN) 202311129998.0

(51) Int. Cl. H04N 23/16; H04N 23/84

(52) U.S. Cl. CPC H04N 23/16; H04N 23/84

(57) ABSTRACT

A camera includes a light guiding module, an image sensing module, a spectrometer module, and a processor. The light guiding module is configured to receive external incident light and split the incident light into a first light and a second light. The image sensing module is configured to receive the first light and convert the first light into image data. The spectrometer module is configured to receive the second light and obtain spectral information of the second light. The processor is configured for adjusting image data based on the spectral information. The image data includes data of a plurality of pixels, and data of each pixel includes intensities information of three primary colors of light. The processor is configured to adjust the intensity information of each primary color of light in the data of the pixels based on the spectral information.

### FIELD

The subject matter herein relates to a camera and a method for adjusting image data.

### BACKGROUND

A camera generally receives and records intensities of red light, green light, and blue light (RGB light) of incident light by an image sensor, thereby recording images. However, the RGB light recorded by the image sensor usually cannot cover all bands of the real incident light, which can lead to distortion of color of the recorded image. A conventional solution to solve this problem is to adjust the intensity information of the RGB light recorded by the image/image sensor by algorithms to compensate the image, which still cannot restore the true incident light.

Therefore, there is room for improvement in the art.

### BRIEF DESCRIPTION OF THE DRAWINGS

Implementations of the present technology will now be described, by way of embodiments only, with reference to the attached figures.

FIG. 1 is a view of a camera according to a first embodiment of the present disclosure.

FIG. 2 is a view showing a placement of a spectrometer sensor according to a first embodiment of the present disclosure.

FIG. 3 is a view showing a placement of a spectrometer sensor according to a second embodiment of the present disclosure.

FIG. 4 is a view showing a placement of a spectrometer sensor according to a third embodiment of the present disclosure.

FIG. 5 is a view showing a placement of a spectrometer sensor according to a fourth embodiment of the present disclosure.

FIG. 6 is a working principle diagram of a processor according to an embodiment of the present disclosure.

FIG. 7 is a view of a camera according to a second embodiment of the present disclosure.

FIG. 8 is a view of a camera according to a third embodiment of the present disclosure.

FIG. 9 is a flowchart of a method for adjusting image data of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “coupled” is defined as coupled, whether directly or indirectly through intervening components, and is not necessarily limited to physical connections. The connection can be such that the objects are permanently coupled or releasably coupled. The term “comprising” when utilized, means “including, but not necessarily limited to”; it specifically indicates open-ended inclusion or membership in the so-described combination, group, series, and the like.

### First Embodiment

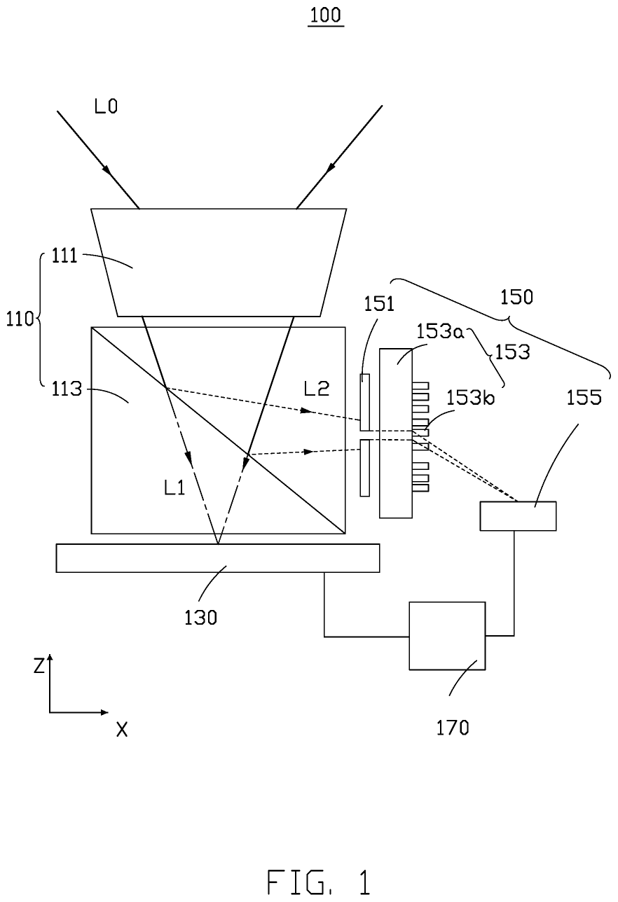

The first embodiment of this disclosure provides a camera. As shown in FIG. 1, the camera 100 includes a light guiding module 110, an image sensing module 130, a spectrometer module 150, and a processor 170. The light guiding module 110 is used to receive external incident light L0 and split the incident light L0 into a first light L1 and a second light L2. The external incident light L0 is light reflected or/and directly emitted from a target to be captured by the camera 100. The image sensing module 130 is used to receive the first light L1 and convert the first light L1 into image data. The spectrometer module 150 is used to receive the second light L2 and obtain spectral information of the second light L2. The processor 170 is electrically connected to the image sensing module 130 and the spectrometer module 150, and configured for adjusting image data based on the spectral information. The image data includes data of a plurality of pixels, and data of each pixel includes intensities information of three primary colors of light. The processor 170 is used to adjust the intensity information of each primary color of light in the pixel data based on the spectral information.

The light guiding module 110 includes a lens module 111 and a beam splitter module 113. The lens module 111 is used to receive the incident light L0. The beam splitter module 113 is used to transmit the first light L1 and reflect the second light L2. Specifically, the lens module 111 is a lens or a lens group used to converge the incident light L0 for obtaining the image data. The beam splitter module 113 is a semi-transparent and semi-reflective element, and used to allow a portion of the incident light L0 to pass through and reflect a remaining portion of the incident light L0, thereby splitting the incident light L0 into the first light L1 and the second light L2, guiding the first light L1 to the image sensing module 130, and guiding the second light L2 to the spectrometer module 150. The first light L1 and the second light L2 contain the same color information. That is, the first light L1 and the second light L2 split by the splitting module 113 retain the color information of the incident light L0.

In this embodiment, the beam splitter module 113 is a beam splitter prism including two right-angled prisms. The inclining surfaces of the two right-angled prisms are adhered to each other, and a semi-transparent and semi-reflective film is set on the inclining surface of one of the two right-angled prisms. When the incident light L0 is incident on the semi-transparent and semi-reflective film, a portion of the incident light L0 passes through the semi-transparent and semi-reflective film, while other portion of the incident light L0 is reflected by the semi-transparent and semi-reflective film, thus splitting the beam to form the first light L1 and the second light L2. In another embodiment, the semi-transparent and semi-reflective beam splitter module 113 can also be a flat beam splitter (not shown). That is, a semi-transparent and semi-reflective film is on the surface of a plate shaped transparent substrate to split the incident light L0.

The beam splitter module 113 can also be used for other types of beam splitter optical components, and the present disclosure is not limited to this. As long as the beam splitter module 113 can split the incident light L0 into the first light L1 and the second light L2 having the same color information, which are within a scope of this disclosure.

The image sensing module 130 can be a photoelectric conversion element such as a charge coupled device (CCD) or a complementary metal-oxide semiconductor (CMOS). The image sensing module 130 can be divided into a plurality of pixel regions. Each pixel region is used to record light intensity information of a group of RGB primary colors of light, which is recorded as the color information of the pixel region in the pixel data. The pixel data of all of the pixel regions are combined to form the image data recording the incident light L0.

The spectrometer module 150 includes a slit 151, a superlens 153, and a spectrometer sensor 155. The slit 151 is between the light guiding module 110 and the superlens 153, and configured to block a portion of the second light L2. The superlens 153 is used to disperse the second light L2, causing the second light L2 to diverge a plurality of beams of monochromatic light having different wavelengths. Emission angles of different monochromatic light are arranged according to the wavelength. The spectrometer sensor 155 is used to receive the dispersed second light L2 and record the color and intensity of each monochromatic light, thereby recording the spectral information of the second light L2.

The slit 151 is configured to limit the second light L2 input to the spectrometer sensor 155. That is, the slit 151 is used to control a cross-sectional size of the second light L2 incident on the superlens 153, thereby controlling a cross-sectional size of light spot incident on the spectrometer sensor 155 after dispersion. Specifically, the smaller the size of the slit 151, the smaller the cross-sectional size of the second light L2 incident on the superlens 153, and the smaller the cross-sectional size of the dispersed second light L2 emitted from the superlens 153. At this time, the spectrometer sensor 155 can obtain more accurate spectral information even if the spectrometer sensor 155 is closer to the superlens 153. However, the smaller the cross-sectional size of the beam, the higher the accuracy requirement for the placement of the spectrometer sensor 155. When the size of the slit 151 increases, the size of the second light L2 incident on the superlens 153 increases, and the cross-sectional size of the dispersed second light L2 emitted from the superlens 153 increases. At this time, the spectrometer sensor 155 needs to be far away from the superlens 153 to avoid spots of the dispersed second light L2 overlapping on the spectrometer sensor 155, thereby increasing an overall volume of the spectrometer module 150. However, the larger cross-sectional size of the beam reduces the placement accuracy of the spectrometer sensor 155, which also reduces the assembly difficulty.

The superlens 153 includes a transparent substrate 153a and a plurality of nanostructures 153b on the substrate 153a. Each nanostructure 153b has a columnar shape and a dimension ranging from tens of nanometers to hundreds of nanometers. The nanostructures 153b are arranged in an array on the substrate 153a to achieve dispersion of the second light L2. It is advantageous in reducing a number of elements that cause dispersion of the second light L2, reducing the volume of the spectrometer module 150, and improving space utilization by setting the superlens 153 as the dispersion element of the second light L2.

In this embodiment, the superlens 153 transmits the dispersed second light L2 to the spectrometer sensor 155. In other embodiments, the superlens 153 can also reflect the dispersed second light L2 onto the spectrometer sensor 155. The superlens 153 can be set to transmit or reflect the dispersed second light L2 based on actual optical path design and needs to improve space utilization. As long as the superlens 153 can disperse the second light L2, it is within a scope of this disclosure.

The spectrometer sensor 155 can be a one-dimensional linear photoelectric sensor, a two-dimensional narrow width photoelectric sensor, or an array photoelectric sensor.

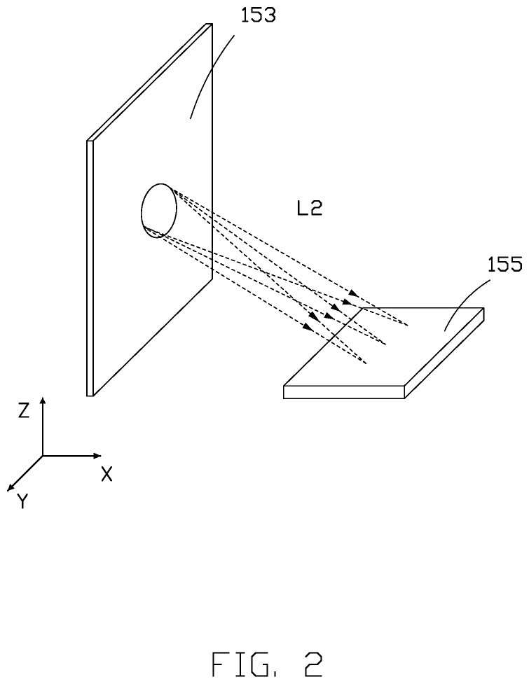

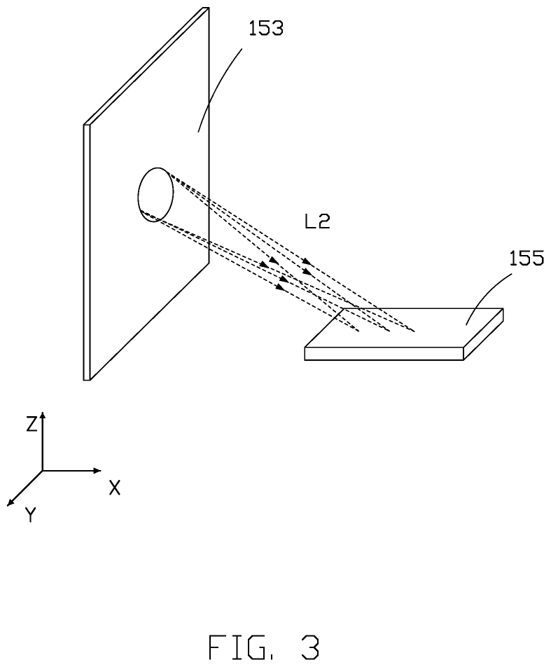

As shown in FIG. 2 and FIG. 3, in this embodiment, the placement of the spectrometer sensor 155 can be determined based on the dispersion direction of the second light L2. Specifically, the divergent second light L2 emitted from the superlens 153 have different colors and different colors of the divergent second light L2 can be arranged along a second direction Y parallel to the superlens 153, or along the first direction X perpendicular to the superlens 153. According to arrangement direction of the divergent second light L2, it is necessary to set the placement position of the spectrometer sensor 155. For example, when the spectrometer sensor 155 is placed perpendicular to a third direction Z, and different colors of the divergent second light L2 is arranged along the first direction X or the second direction Y, the spectrometer sensor 155 also needs to adjust its position accordingly to receive multiple beams of diverging second light L2.

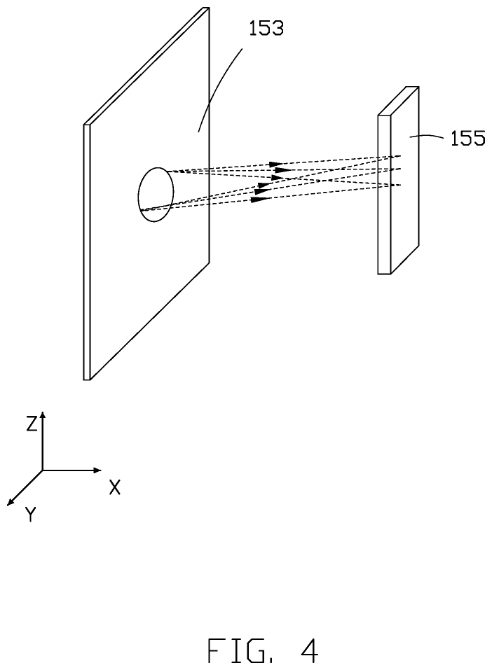

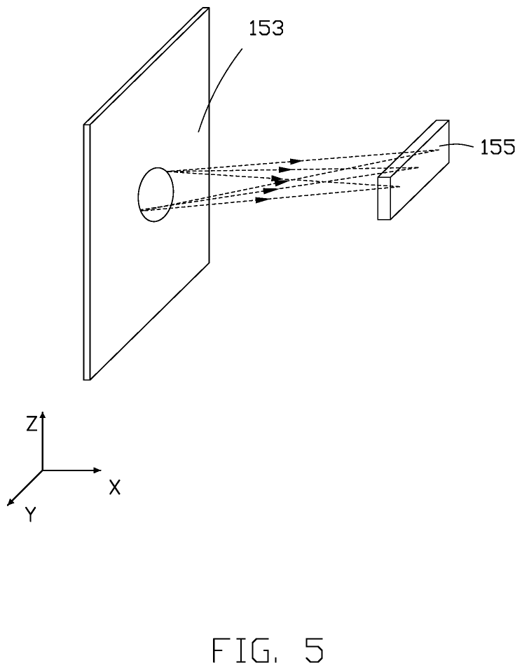

As shown in FIG. 4 and FIG. 5, in other embodiments, the spectrometer sensor 155 can also be placed perpendicular to the first direction X. Specifically, the placement position of the spectrometer sensor 155 is determined by deflection direction of the second light L2. When the second light L2 exits in the first direction X, the spectrometer sensor 155 can be set to be perpendicular to the first direction X. The placement direction of the spectrometer sensor 155 is also related to the dispersion direction of the second light L2. When the divergent second light L2 is arranged along the third direction Z or the second direction Y, the spectrometer sensor 155 also needs to adjust its position accordingly to receive multiple divergent beams of the second light L2.

The working wavelengths of the image sensing module 130 and the spectrometer module 150 can be the same section or different sections, depending on the specific usage needs.

In this embodiment, the processor 170 may be a central processing unit or other integrated circuit, which is not limited. The processor 170 can be integrated with the image sensing module 130 on a same circuit board. The processor 170 can be integrated with the spectrometer sensor 155 on a same circuit board. Or the processor 170 can be independent from the image sensing module 130 and the spectrometer sensor 155.

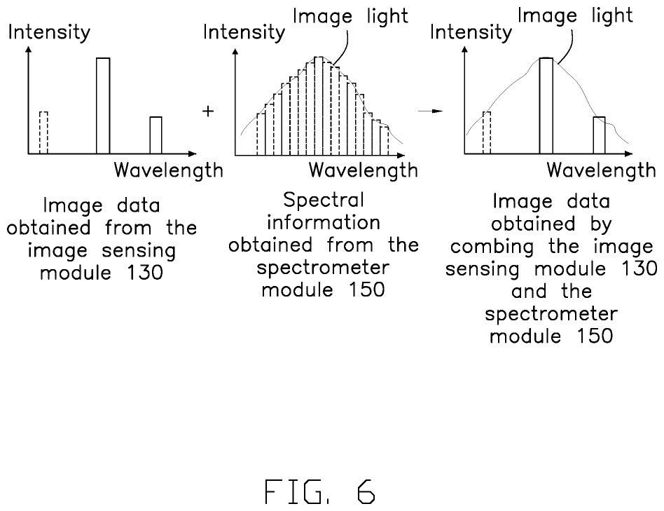

As shown in FIG. 6, the processor 170 is used to receive image data collected by the image sensing module 130 and spectral information obtained by spectrometer module 150, and adjust the image data based on the spectral information. Specifically, the incident light L0 typically includes multiple wavelengths of light, each wavelength of light has different light intensities, thus combining to form light of different colors. The image data collected by the image sensing module 130 only includes the intensity of the primary colors of light in three different bands, so the intensity information of light of other bands cannot be collected by the image sensing module 130. The spectral information includes the intensity information of multiple bands of light, so it is more accurate in restoring the color information of the incident light L0 compared to the image data. Based on the spectral information, the intensity of the three primary colors of light in the image data can be adjusted accordingly, so that the recorded colors in the image data are closer to the actual incident light L0. That is, the spectral information can be split into data containing only three primary colors of light, thereby decomposing information of other bands of light into three primary colors of light, and adjusting a ratio between the intensities of the three primary colors of light in the image data based on a ratio between the intensities of the three primary colors of light.

In this embodiment, the image sensing module 130 can also operate independently as a regular camera, and the spectrometer module 150 can also be used independently as a spectrometer.

The camera 100 provided in the present embodiment can be set to include both an image sensing module 130 and a spectrometer module 150. The spectral information of the incident light L0 can be obtained by the spectrometer module 150, thereby adjusting the image data obtained by the image sensing module 130 to better restore the true color of the incident light L0 and improve the image recording effect. By setting the spectrometer module 150 including the superlens 153, it is beneficial to reduce a number of dispersion elements, thereby reducing the volume and improving spatial utilization of the camera 100. By setting the image sensing module 130 and the spectrometer module 150 to work separately, it is beneficial to improve application scenarios of the camera 100.

### Second Embodiment

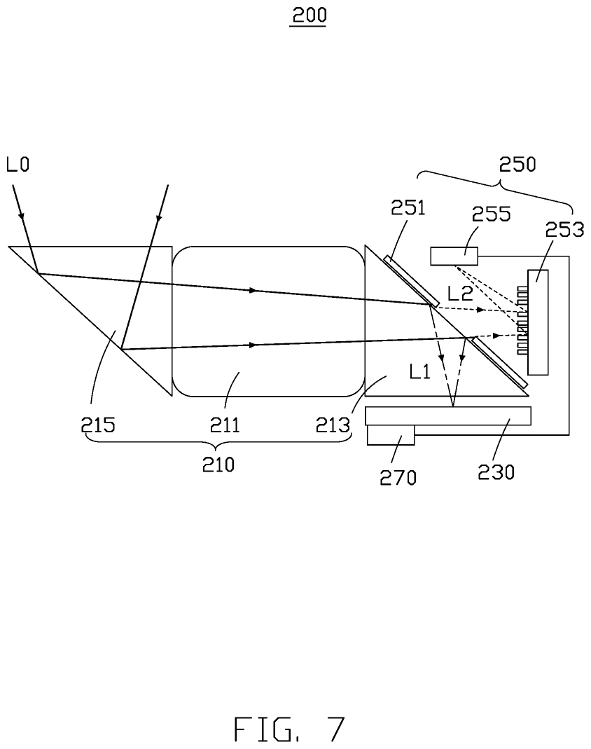

As shown in FIG. 7, a camera 200 includes a light guiding module 210, an image sensing module 230, a spectrometer module 250, and a processor 270. The light guiding module 210 is used to receive external incident light L0 and split the incident light L0 into a first light L1 and a second light L2. The image sensing module 230 is used to receive the first light L1 and convert the first light L1 into image data. The spectrometer module 250 is used to receive the second light L2 and obtain spectral information of the second light L2. The processor 270 is electrically connected to the image sensing module 230 and the spectrometer module 250, and configured for adjusting image data based on the spectral information. The image data includes data of a plurality of pixels, and data of each pixel includes light intensities information of three primary colors of light. The processor 270 is used to adjust the intensity information of each primary color of light in the pixel data based on the spectral information.

The difference between this embodiment and the first embodiment is that the light guiding module 210 includes a lens module 211, a beam splitting module 213, and a reflection module 215. The reflection module 215 is used to receive the incident light L0 and reflect the incident light L0 onto the lens module 211. The lens module 211 is used to receive the incident light L0 and emit the incident light L0 onto the beam splitting module 213. The beam splitter module 213 is used to reflect the first light L1 and transmit the second light L2. That is, the reflection module 215, the lens module 211, and the beam splitter module 213 are arranged in sequence.

The reflection module 215 can include either a prism or a planar mirror. Specifically, the reflection module 215 can be a right-angled prism that reflects the incident light L0 onto the lens module 211 based on a principle of total reflection on the inclined plane. The incident light L0 can also be reflected by coating a reflection film on the inclined plane to reflect the incident light L0. The reflection module 215 can also be a planar reflector that directly reflects the incident light L0 onto the lens module 211.

The beam splitter module 213 can include either a prism or a flat beam splitter. Specifically, the beam splitting module 213 can be a right-angled prism, which splits the incident light L0 into the first light L1 and the second light L2 by setting a semi-transparent and semi-reflective film on an inclined surface. The image sensing module 230 is located on a right-angled surface of the right-angled prism to receive the reflected first light L1. The spectrometer module 250 is located on the inclined surface of a right-angled prism to receive the transmitted second light L2. The slit 251 is on the inclined surface of the right-angled prism. The superlens 253 is on an optical path of the second light L2, and is spaced apart from the slit 251. The superlens 253 is used to reflect the second light L2 onto the spectrometer sensor 255. In other embodiments, the beam splitter module 213 can also be a beam splitter prism composed of two right-angled prisms, or a flat beam splitter. The superlens 253 can also allow the second light L2 to pass through.

The camera 200 can adjust its structure by setting relative positions between the lens module 211, the beam splitter module 213, and the reflection module 215 in the light guiding module 210, which can correspondingly change positions of the image sensing module 230 and the spectrometer module 250, thereby improving space utilization.

### Third Embodiment

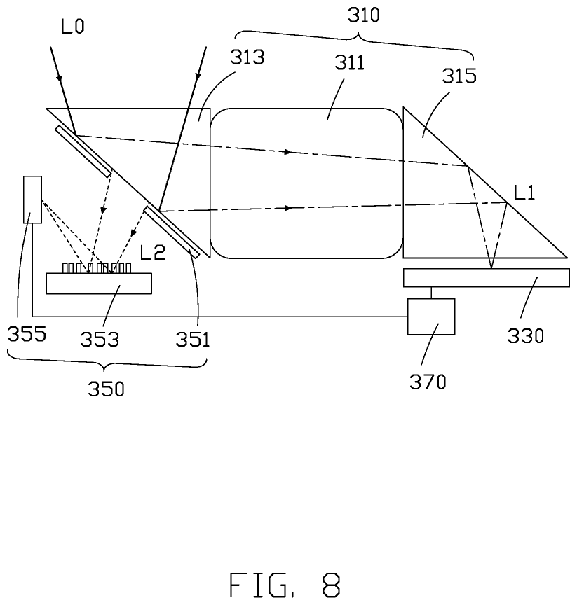

As shown in FIG. 8, a camera 300 includes a light guiding module 310, an image sensing module 330, a spectrometer module 350, and a processor 370. The light guiding module 310 is used to receive external incident light L0 and split the incident light L0 into a first light L1 and a second light L2. The image sensing module 330 is used to receive the first light L1 and convert the first light L1 into image data. The spectrometer module 350 is used to receive the second light L2 and obtain spectral information of the second light L2. The processor 370 is electrically connected to the image sensing module 330 and the spectrometer module 350, and configured for adjusting image data based on the spectral information. The image data includes data of a plurality of pixels, and data of each pixel includes intensities information of three primary colors of light. The processor 370 is used to adjust the intensity information of each primary color of light in the pixel data based on the spectral information.

The difference between this embodiment and the first embodiment is that the light guiding module 310 includes a lens module 311, a beam splitting module 313, and a reflection module 315. The beam splitter module 313 is used to receive the incident light L0, reflect the first light L1 to the lens module 211, and transmit the second light L2 to the spectrometer module 350. The lens module 311 is used to receive and emit the first light L1. The reflection module 315 is used to receive the first light L1 emitted from the lens module 311 and reflect the first light L1 to the image sensing module 330. The beam splitting module 313, the lens module 311, and the reflection module 315 are arranged in sequence.

The beam splitter module 313 can include either a prism or a flat beam splitter. Specifically, the beam splitting module 313 can be a right-angled prism and a semi-transparent and semi-reflective film is coated on an inclined surface of the right-angled prism, which splits the incident light L0 into the first light L1 and the second light L2. The spectrometer module 350 is located on a side of the right-angled prism having the inclined surface to receive the transmitted second light L2. The slit 351 is set on the inclined surface of the right-angled prism, and the superlens 353 is set on an optical path of the second light L2, and is spaced apart from the slit 351. The superlens 353 is used to reflect the second light L2 onto the spectrometer sensor 355. In other embodiments, the beam splitter module 313 can also be a beam splitter prism composed of two right-angled prisms, or a flat beam splitter. The superlens 353 can also transmit the second light L2. Specific structures of the beam splitter module 313 and the spectrometer module 350 can be set according to specific needs.

The reflection module 315 is set on a side of the lens module 311 that emits the first light L1, for reflecting the first light L1 onto the image sensing module 330. The reflection module 315 includes either a prism or a plane mirror. Specifically, the reflection module 315 can be a right-angled prism, which reflects the first light L1 incident on the inclined surface to the image sensing module 330 according to a principle of total reflection. It can also be achieved by coating a layer of reflection film on the inclined surface of the right-angled prism to reflect the first light L1. The reflection module 315 can also be a plane mirror, which can directly reflect the first light L1 onto the image sensing module 330.

The camera 300 can adjust its structure by setting relative positions between the lens module 311, the beam splitter module 313, and the reflection module 315 in the light guiding module 310, which can correspondingly change positions of the image sensing module 330 and the spectrometer module 350, thereby improving space utilization.

### Fourth Embodiment

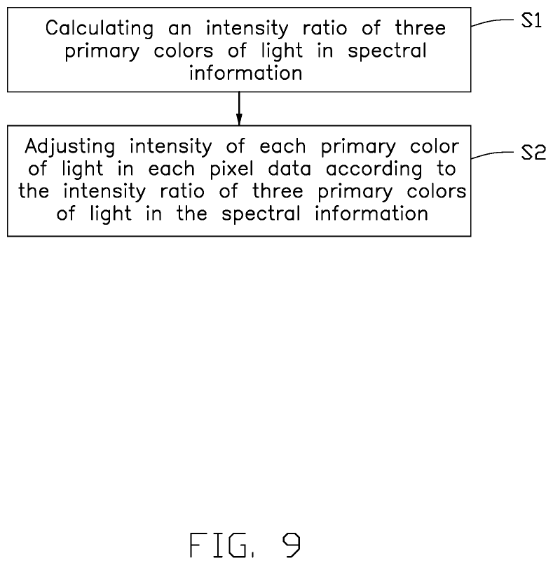

FIG. 9 illustrates a method for adjusting image data that can be applied to any camera in the first to the third embodiment. The method includes following steps S1 to S2.

Step S1: calculating a ratio of three primary colors of light in the spectral information.

Step S2: adjusting intensity of each primary color of light in data of each pixel based on the ratio of three primary colors of light in the spectral information.

Specifically, the camera simultaneously obtains the image data and the spectral information for recording the incident light L0. The image data includes data of a plurality of pixels. The data of each pixel is used to record color and brightness of a portion of the incident light L0. The data of each pixel are combined to form a recorded image. The data of each pixel includes intensity information of three primary colors of light, which are mixed together to form the color of a pixel. The spectral information records an overall spectral information of the incident light L0. That is, the intensities of different bands of light included in the incident light L0 as a whole are recorded. The image data can only record the intensity of the three primary colors of light, and cannot record the light intensity of other bands. Therefore, in step S1, the spectral information can be divided into three primary colors of light and the intensity ratio of the three primary colors of light can be obtained to obtain the intensity ratio of the three primary colors of light of the incident light L0. In step S2, based on the intensity ratio of the three primary colors of light in the spectral information, the intensity of each primary color of light in data of each pixel can be adjusted to make the image data closer to the incident light L0.

In this embodiment, the method for adjusting image data further includes following steps S21 to S23.

Step S21: obtaining a type and a number of the primary colors of light included in a display module for displaying image data.

Step S22: calculating an intensity ratio of the primary colors of light of the display module in the spectral information based on the type and the number of primary colors of light included in the display module.

Step S23: adjusting the image data to include data about the intensities of the primary color of lights in the display module according to the intensities of the three primary colors of light in the image data and the intensity ratio of the primary color of lights of the display module in the spectral information.

Specifically, a current image sensing module typically records the light intensities data of the three RGB primary colors of light to record the color of each pixel. However, in addition to a common display based on the three RGB primary colors of light, there are other display modules based on other types and numbers of primary colors of light, such as RGBY pixel containing yellow light or RGBW pixel containing white light. The image data usually directly converts into data of the primary colors of light of the display module during display, but there may still be distortion of recorded information. In step S22, the intensity ratios of various primary colors of light of the display module can be obtained based on the spectral information. In step S23, the image data and the spectral information can be combined together to adjust the light intensities of original RGB three primary colors of light of the image data, and generate intensity data of other primary colors of light. For example, when the display module is displayed in RGBY pixels, the intensity ratio of the red light, green light, blue light, and yellow light in the incident light L0 can be obtained by spectral information. Based on this, the intensity of the red light, green light, and blue light in the image data can be adjusted, and yellow light data can be generated, thus image data including the intensity information of the four primary colors RGBY of light is obtained.

In this embodiment, the steps S1 and S2 can be performed to adjust the image data, and then the steps S21, S22, and S23 can be performed when the image needs to be displayed. In other embodiments, step S21 can also be performed first, and it can be determined whether the display module only includes the RGB three primary colors of light. If yes, the steps S1 and S2 can be performed; if not, the steps S22 and S23 can be performed. The steps S1 and S2 can be performed separately, or the steps S21, S22, and S23 can be performed separately.

The method for adjusting image data provided in the present embodiment obtains the intensity ratio of the primary colors of light in the spectral information, and then adjusts the image data accordingly, which is beneficial for making the color information recorded in the image data closer to the incident light L0, thereby making the image data more accurate in restoring the true color of the incident light L0 and improving the image recording effect.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A camera comprising:
a light guiding module configured to receive incident light external to the camera and split the incident light into a first light and a second light;
an image sensing module configured to receive the first light and convert the first light into image data;
a spectrometer module configured to receive the second light and obtain spectral information of the second light; and
a processor electrically connected to the image sensing module and the spectrometer module, the processor being configured for adjusting image data based on the spectral information;
wherein the image data comprises data of a plurality of pixels, and data of each of the plurality of pixels comprises intensities information of three primary colors of light, the processor is further configured to adjust the intensity information of each of the three primary colors of light in the data of the plurality of pixels based on the spectral information.

2. The camera of claim 1, wherein the light guiding module comprises a lens module and a beam splitter module; the lens module is configured to receive the incident light;
the beam splitter module is configured to transmit the first light and reflect the second light.

3. The camera of claim 2, wherein the beam splitter module is semi-transparent and semi-reflective; the beam splitter module is configured to transmit a portion of the incident light and reflect a remaining portion of the incident light.

4. The camera of claim 3, wherein the beam splitter module is a beam splitter prism comprising two right-angled prisms; each of the two right-angled prisms comprises an inclining surface; inclining surfaces of the two right-angled prisms are adhered to each other, and a semi-transparent and semi-reflective film is on the inclining surface of one of the two right-angled prisms.

5. The camera of claim 1, wherein the spectrometer module comprises a superlens and a spectrometer sensor; the superlens is configured to disperse the second light, the spectrometer sensor is configured to receive dispersed second light.

6. The camera of claim 5, wherein the superlens comprises a transparent substrate and a plurality of nanostructures on the substrate; each of the plurality of nanostructures has a columnar shape and a dimension ranging from tens of nanometers to hundreds of nanometers.

7. The camera of claim 6, wherein the plurality of nanostructures is arranged in an array on the substrate.

8. The camera of claim 5, wherein the superlens is configured to transmit the dispersed second light to the spectrometer sensor.

9. The camera of claim 5, wherein the superlens is configured to reflect the dispersed second light onto the spectrometer sensor.

10. The camera of claim 5, wherein the spectrometer module further comprises a slit; the slit is between the light guiding module and the superlens, and configured to block a portion of the second light.

11. The camera of claim 1, wherein the light guiding module comprises a lens module, a beam splitting module, and a reflection module;
the reflection module is configured to receive the incident light and reflect the incident light onto the lens module;
the lens module is configured to receive the incident light and emit the incident light onto the beam splitting module; and
the beam splitter module is configured to reflect the first light and transmit the second light.

12. The camera of claim 1, wherein the light guiding module comprises a lens module, a beam splitting module, and a reflection module;
the beam splitter module is configured to receive the incident light, reflect the first light to the lens module, and transmit the second light to the spectrometer module;
the lens module is configured to receive and emit the first light;
the reflection module is configured to receive the first light emitted from the lens module and reflect the first light to the image sensing module.

13. A method for adjusting image data, the adjusting method being applied in the camera of claim 1, the method comprising:
calculating an intensity ratio of three primary colors of light in the spectral information; and
adjusting the intensity of each of the three primary color of light in data of each pixel according to the intensity ratio of the three primary colors of light in the spectral information.

14. The method for image data of claim 13 further comprising:
obtaining a type and a number of primary colors of light included in a display module configured for displaying the image data;
calculating an intensity ratio of the primary colors of light of the display module in the spectral information based on the type and the number of primary colors of light included in the display module; and
adjusting the image data to include data of the intensities of the primary color of lights in the display module according to the intensities of the three primary colors of light in the image data and the intensity ratio of the primary color of lights of the display module in the spectral information.
